(19) United States
(12) Patent Application Publication
(10) Pub. No.: US 2023/0264146 A1
(43) Pub. Date: Aug. 24, 2023

(54) SYSTEM FOR THE REMOVAL OF HYDROGEN/OXYGEN IN A GASEOUS STREAM

(71) Applicant: Enapter S.r.l., Crespina Lorenzana (IT)

(72) Inventors: Thorben BUSCH, Saerbeck (DE); Ralph CALDECOTT, Crespina Lorenzana (IT); Claudio AIELLO, Crespina Lorenzana (IT); Sean Crawford CHAPMAN, Crespina Lorenzana (IT); Antonio FILPI, Crespina Lorenzana (IT); Jan-Justus SCHMIDT, Crespina Lorenzana (IT); Max-Istvan SCHMIDT, Crespina Lorenzana (IT)

(21) Appl. No.: 18/043,545

(22) PCT Filed: Aug. 31, 2021
(86) PCT No.: PCT/EP2021/074057

§ 371 Date: Feb. 28, 2023

(30) Foreign Application Priority Data
Sep. 1, 2020 (GB) 2013706.3

(51) Int. Cl. B01D 53/86; C25B 9/23; C25B 9/60; C25B 15/027; C25B 15/033; C25B 15/029; C25B 15/08; B01D 53/32; B01D 53/88

(52) U.S. Cl. CPC B01D 53/8671; B01D 53/326; B01D 53/88; C25B 9/23; C25B 9/60; C25B 15/027; C25B 15/029; C25B 15/033; C25B 15/085; B01D 2255/1021; B01D 2255/1023; B01D 2256/12; B01D 2257/108

(57) ABSTRACT

According to one embodiment of the present invention there is provided a combiner for the removal of hydrogen/oxygen gas in a gaseous stream, said combiner comprising: a pipe capable of accommodating the flow of a gaseous stream, wherein the pipe is adapted to transmit the gaseous stream to a catalytically active structure (CAS), the CAS having: contact with the substantial majority of the gaseous stream, a housing, and an inlet, said inlet being connected to the pipe, and an outlet, for the removal of the gaseous stream post recombination, and a second pipe connected to the outlet of the CAS for the transmission of the gaseous stream away from the combiner. A second embodiment of the invention sees the CAS housed within an electrochemical cell directly.

The present invention relates to a means, and a method for the removal of hydrogen in a gaseous stream comprising at least some oxygen. The present invention is intended for use with, but is not necessarily limited to, the oxygen containing output from an electrolyser.

Hydrogen has a multitude of applications, ranging from energy storage to the production of fertilisers. Hydrogen can be derived from many sources, these are often given colours. Gray hydrogen is derived from fossil fuels such as natural gas or oil. Blue hydrogen is derived in a similar manner to Gray with carbon capture techniques. Green hydrogen is obtained with no carbon emissions and is achieved often by utilising renewable energy, and electrolysers. Some of these sources, Blue and Gray, are undesirable for obvious reasons. Therefore, there is a need to be able to produce hydrogen in a reliable and sustainable manner.

Electrolysers are devices used for the generation of hydrogen and oxygen by electrochemically splitting water. Electrolysers generally fall in one of three main technologies currently available, namely anion exchange membrane (AEM), proton exchange membrane (PEM), and liquid alkaline systems. Liquid alkaline systems are the most established technology being known for well over a century. PEM systems are also established having been available commercially for decades. AEM electrolysers are a relatively new technology. Other technologies, such as solid oxide electrolysis are available.

It is possible to operate an electrolyser to produce hydrogen at pressure, especially AEM systems. A result of operating at pressure is potential hydrogen crossover. Hydrogen presence in a stream comprising oxygen is of particular concern should a source of ignition occur or be present.

At present, the risk is mitigated in a variety of ways, such as by ensuring adequate ventilation at the outlet to reduce the chance of hydrogen levels surpassing potentially hazardous limits. Other options include operating at a lower cathodic pressure, which places more requirement on the compression system to be used, or a thicker membrane. Varying these parameters may negatively impact the efficiency of the electrolyser or wider system.

In PEM electrolysers, it has been documented to place a recombination interspersed throughout the membrane. This may reduce overall efficiency and is not appropriate for all electrochemical devices. Such an approach as disclosed in literature is not suitable for use with electrochemical devices utilising an AEM due to the anodic potentials and higher pH. Therefore a novel approach was found to be required for AEM electrochemical devices.

Hydrogen and oxygen may become mixed in a variety of situations. This can be problematic as a mixture of hydrogen in oxygen is flammable in the range of 4% to 75% (volumetric). Such a mixture is capable of detonation between 18.3% and 59% (volumetric) hydrogen in oxygen. The invention described herein may be applied to any such circumstance to ensure the safety of a mixture which may encroach a hazardous threshold.

The object of the present invention is to provide an improved means, and method for the removal of hydrogen in a gaseous stream comprising at least some oxygen.

According to one embodiment of the present invention there is provided a combiner device for, in use, removing a hydrogen contaminant in a principal gas stream comprising predominantly oxygen, or vice versa, with said combiner device comprising:
a catalytically active structure (CAS) comprising a housing having an inlet and an outlet;
a first pipe coupled to the inlet for conveying said principal gas stream into the housing such that it flows from the inlet to the outlet, and an exhaust pipe for conveying said principal gas stream away from said housing;
the CAS further comprising a structural element comprising or including a catalytic material operable to combine hydrogen and oxygen to form water, the structural element being located within the housing, part way between the inlet and the outlet, and extending across a substantial majority of a cross-section thereof, such that, in use, the principal gas stream flows therethrough.

As used herein, the term “pipe” is used to include, but is not limited to, pipework including piping made from a variety of materials such as copper, stainless steel, polymer/plastic, and aluminium. Pipe, or piping is meant to cover any and all means for the transmission of gas or fluids.

As used herein, the terms “gas stream” and “gaseous stream” is used to include any gaseous stream comprising at least hydrogen and oxygen. Alternatively, the term “fluid” may be used. Other potential contaminants, depending on the nature of the stream, should be addressed by other appropriate means for removal. The gaseous stream may comprise vapour and or liquid in any combination with gas. In the preferred application, water is most likely.

As used herein, the terms “inlet” and “outlet” are used to include more traditional inlets/outlets, such as a pipe to or from a housing. Additionally, the terms are used to include any place or means of entry or departure of fluids from that section of a system.

As used herein, the term “catalytically active structure” (CAS) is used to include, but is not limited to any surface or structure which is catalytically active by the presence of a catalyst. Such surfaces include membranes, cloths, structures or equivalents. A preferred embodiment is a catalytic bed reactor, a catalytic converter, catalytic burner or other name.

As used herein, reference to hydrogen/oxygen is used to include the presence of either oxygen or hydrogen, depending upon the application of the combiner. A combiner used in a preferred application with an electrolyser may be used to remove hydrogen from a predominantly oxygen stream from the anode, or to remove any potential oxygen in a predominantly hydrogen stream from the cathode. Generally, the minority component of the gaseous stream will be removed.

As used herein, the term “combustion” is used to include, but is not limited to recombination of hydrogen and oxygen. Combustion is used interchangeably with other terms such as recombination. Generally it is the removal of hydrogen that is referred to as in the preferred application, it will be a minority of hydrogen present relative to oxygen.

As used herein, the term “demister”, and “demister pad” are used interchangeably. The used of pad is not necessarily intended to limit the geometry of the demister.

In a preferred embodiment of the present invention, the CAS is house in a substantially closed housing with the only access being via the inlet and outlet pipes as described herein. Ambient air, or other fluids, are not intended to be able to permeate the housing.

The present invention is intended to work with a gaseous stream comprising both hydrogen and oxygen. Preferably, either oxygen or hydrogen is the majority component in the gaseous stream. More preferably still, the contaminant (or “minority”) gas comprises between 0.1% and 50%, more preferably still 0.1% and 20%, and even more preferably still, between 0.1% and 10% of the gaseous stream. During normal operation it is envisaged to be between 0.01% and 5%. Example compositions include 90% oxygen and 10% hydrogen. 99.9% oxygen and 0.1% hydrogen, vice versa and any range in between. For the complete removal of a contaminant gas, assuming only hydrogen and oxygen, the composition is limited by the stoichiometry of the reaction. In some instances, the contaminant gas may be over 50%, although such a scenario is not desirable.

The present invention may be adapted to work at a variety of temperatures, by varying components such as the catalyst. In the preferred embodiment, the temperature is above room temperature (20° C.) and below 120° C. More preferably still it is between 60° C. and 110° C. more preferably still the temperature is between 70° C. and 100° C. centring on approximately 90° C. It is noted that the temperature of the CAS may run higher due to the exothermic nature of the reaction, optional insulation and variances in ambient temperatures. Such measurements may be used to indicate incorrect operation.

In some embodiments, there may be a minimum level of contaminant gas required to present in order for the CAS to recombine the gases. In the preferred embodiment means are provided for the provision of the requisite amount of gases for recombination to occur. Such means include recirculation of gases, or the use of a reservoir prior to the combiner, or a combination thereof.

In one embodiment the gaseous stream downstream of the combiner may be recirculated. Recirculation may be automatic, or alternatively controlled by a downstream hydrogen/oxygen sensor which activates the recycle in instances where elevated hydrogen/oxygen is present. Other sensors such as temperature or humidity sensors may be employed and calibrated as an alternative to the hydrogen/oxygen sensor.

In an alternative embodiment wherein hydrogen is the contaminant gas it is envisaged that a metal hydride or other material adapted to adsorb the contaminant gas is present at or before the CAS, upstream of the combiner. As hydrogen adsorbs to the metal hydride, this mitigates contaminant emission until the hydride is at peak adsorption. It is possible to release the hydrogen by either thermal cycling or pressure cycling of the hydride. Such cycling may be based on run time, and conducted at pre-determined intervals, or utilise sensors as discussed above downstream of the combiner to trigger the method of releasing adsorbed hydrogen.

In the embodiment utilising a metal hydride as a hydrogen reservoir decreasing pressure triggers the release of adsorbed hydrogen. For embodiments with thermal regulation, increasing the temperature triggers the release of adsorbed hydrogen.

A product of recombination of hydrogen and oxygen is water. An excess of water may cause flooding of the CAS. The exothermic nature of the reaction mitigates this as the increased temperature causes the excess water to evaporate. In one embodiment of the invention, with intermittent recombination as discussed above, either based on a pre-determined cycle, or threshold for an employed sensor, can help with water management. Intermittent recombination allows for the generated water to be removed from the CAS, by evaporation or other means, whilst still ensuring a safe composition in the output.

Conversely, a reservoir for oxygen may be provided, depending upon what the contaminant gas is in the application.

Regardless of whether it is a hydrogen reservoir or oxygen reservoir employed, it is envisaged that the reservoir may be coupled with the CAS, or a distinct component. Additionally, the reservoir may be housed within the combiner, or upstream of said combiner. In yet another embodiment the reservoir may be downstream of the combiner, and means provided to recycle the gas when release of the adsorbed gas is triggered.

In some embodiments removal and detection is simultaneously achieved by the combiner. Where appropriate, reference to the removal of a gas shall also include reference to the detection of said gas, for embodiments where means for detecting are provided.

In the preferred embodiment of the invention, the entirety of the gaseous stream routed to come into contact with the CAS. This can be achieved by having the CAS cross the substantial majority, if not all, of the cross section of the path the gas mixture flows through, as shown in the figures .

In a preferred embodiment, the combiner is used in combination with an electrochemical device, more preferably an electrolyser, and yet more preferably still an AEM electrolyser. Such electrochemical devices often utilise a water tank, or equivalent. Such water tanks normally have an outlet for the removal of gases. The gaseous stream is usually oxygen, with hydrogen and water as minor contaminants.

It is envisaged that a demister may be placed on the water tank in the aforementioned application. It is envisaged that the combiner claimed herein may be used in series with such a demister, being placed either before or after depending upon the nature of the catalyst. Alternatively, the combiner may be incorporated into a demister housing, or combined with the demister pad itself.

In one embodiment, the demister coupled to the recombiner/CAS may dually act as a flame arrestor and demister. With recombination under confined, low-flow conditions that could occur in start up an shut down, there exists the possibility of weak deflagration that could fully develop into detonation, warranting a flame arrestor at least on the inlet of the recombiner. It is preferred that the flame arrestor is a microporous sintered material, such that it will also demist/coalesce water and prevent direct water introduction into the CAS/reactor chamber. One such embodiment would have a sintered metal coalescing filter attached to the inlet of the CAS chamber for both safety and system resilience under start up and shut down.

It is envisaged that the recombiner device may be coupled with a demister, the CAS being either: upstream of a demister pad; downstream of a demister pad; or combined with a demister pad. It is also envisaged that a demister pad may flank the CAS, meaning a demister pad is present both up and down stream of the CAS.

These embodiments, as other embodiments, may see the demister pad dually acting as a flame arrestor, the composition of such a dual acting demister/flame arrestor described further below.

Another safety consideration involves adding component resilience to static discharge events, which are likely to occur in water saturated gas flows over metal housings/connectors. To circumvent this problem, it is envisaged that a polymeric coating may be applied to any or all internal, metal surfaces of the reactor chamber including the CAS as well. This would guarantee that even in the event of component charging due to improper grounding or ground faults, that any discharge does not occur within the reactor chamber itself.

Whilst it is envisaged that any coating may be hydrophobic or hydrophilic, in a preferred embodiment the polymeric coating or equivalent is hydrophilic. Another embodiment is envisaged to include multiple coating layers, having an insulating backing/priming layer on the metal substrate, and a subsequent conductive and/or hydrophilic coating deposited on the priming layer - the hydrophilic and/or conductive layer serving as an anti-static layer. Said coating may be on the CAS, rest of the device, or both.

In another application, the combiner may be located upon the cathodic outlet for the removal of any oxygen present in the hydrogen outlet, with a drier being used for the removal of any water present, or generated by the recombination.

Whilst in many embodiments it is envisaged that hydrogen is to be removed from a predominantly oxygen stream, conversely a combiner in accordance with the present invention could be used to remove oxygen from a predominantly hydrogen stream. As with other embodiments, means for drying may be provided down stream of the drier to handle the water generated by recombination.

Whilst it is envisaged that the CAS could be any suitably catalytically active surface, in the preferred embodiment the CAS is a catalytic burner. The CAS may have a metal foam as the structural backbone, or a polymeric film, or other suitable structure. The CAS may also be present in a polymer coating on a structure and/or the walls of the housing. Such an embodiment may be PTFE coating platinum supported on an aluminium oxide structure, or suitable alternatives thereof.

Whilst it is envisaged that the CAS will work without the introduction of ambient air, or another gas. In some embodiments, it is preferred to introduce ambient air. This can help ensure complete recombination. Ambient air may be introduced downstream for the dilution of the already processed gaseous stream.

It is envisaged that a variety of catalysts may be used in the CAS for recombination. Both platinum and palladium are understood to work, as well as their alloys. Examples of such catalyst include Pd/Al₂O₃, and PtCo alloys.

In the preferred embodiment, PGM free catalyst are used such as, but not limited to metal alloys, ceramics, chalcogenides, pnictogenides, organometallics, other metal complexes. Some examples include Ni alloys. Any good catalyst for hydrogen oxidation reaction may be used, such as NiLa.

Regardless of the catalyst used, the reaction is as follows:

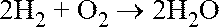

This reaction is the same regardless of whether hydrogen or oxygen is being removed from the gaseous stream. The reaction would occur until the exhaustion of either reactant.

The siting of the combiner relative to the demister, or other drying means, will depend on the nature and preference of the catalyst. Water will be produced in the reaction, as shown above. Some catalysts are hydrophilic operating better in moist conditions. Conversely, some are hydrophobic, preferring drier conditions. The support itself may also be either hydrophilic, or hydrophobic. As water is produced it is envisioned hydrophobic properties are preferred. The CAS may be located before or after a drier or demister, depending upon the preferred characteristics of the catalyst. As the presence of liquid water may inhibit the rate of reaction due to the excess product being present, also known as flooding, it is preferred to provide means for the removal of (generated/excess)water such as but not limited to means for wicking the water, or means such as heating for the evaporation of said water, or a chemical pre-treatment.

In a preferred embodiment, the CAS and demister are adapted to share a housing, the CAS being placed above or below the demister pad, or combined into said demister pad. Means for spacing may be provided to separate the two layers within said housing, or the CAS and demister pad may be in contact. Alternatively, as described above the demister pad and CAS may be combined. Such combination may require a distinct flame arrestor as described above. In embodiments utilising hydrides for hydrogen storage, the hydride may also be housed on or in the demister.

It is envisaged that a variety of supports may be used with any catalyst, not limited to those above, to form the CAS. Preferably, the support should have: mechanical stability; thermal stability; a high surface area, and; water-resistant and corrosion resistant properties. Examples of such supports include carbon black, metal oxides such as ceramics, polymeric film, metal foams such as Ni foam, and zeolites/zeolitic structures, or metal-organic frameworks. Examples of metal oxides likely to be suitable, include but are not limited to Pd/SnO₂ or Pd/TiO₂. It is further envisaged that a combination of the above may be used.

A core-shell model may be applied to either one or both of the substrate and the catalyst. When done for the substrate, one example be Al₂O₃ as a core with a shell of CeO₂, the shell being chosen for a combination of: thermal stability, water retention properties, corrosion resistance and water resistance, and other properties related to the longevity of the substrate. With regards to the catalyst, the core shell configuration allows for the reduction of PGM loading, or other catalyst for non-PGM embodiments. An example would be a Co core with a shell of Pt.

In an embodiment of the present invention, the means for the removal of hydrogen is further adapted to include a means for detecting the presence of hydrogen and oxygen as well. This may be achieved by correlating the temperature of the CAS to expected temperature achieved by empirical analysis. The recombination of hydrogen and oxygen and hydride formation are both exothermic reactions. It is envisaged that the present invention may be further adapted to also be a hydrogen or oxygen sensor, as well as a recombiner. A thermocouple, or other temperature sensing means, shall be used to measure the temperature of the CAS. The temperature may be correlated to the ratio of the contaminant gases present. Flowrate should also be considered, furthermore embodiments utilizing hydrides should also account for this in correlation. By measuring the temperature, it is possible to determine the ratio of the gases present. Such information may be used to inform of a leak, or potential risk and as such can be used in the control system of the device.

A means of controlling/regulating the CAS reactor temperature is needed insofar as one needs to maintain safety, a minimum threshold of contaminant gas content in the effluent, and reduced likelihood of reactor flooding. Thus, in some embodiments a thermal sensor/thermocouple, a means for heating, and a PID controller are utilized in such a way as to regulate the operating temperature of the reactor to a predetermined setpoint to ensure efficiency of the reaction. Further, for a given steady state temperature, one can deduce the reaction rate and thus the content of the effluent contaminant gas stream from the heater output data utilized in said PID controller. The addition of a temperature sensor controlled heater allows for the start up and shut down of the recombiner in phases with varied composition, the operating temperature may be sustained without the gaseous flow to ensure self-sustaining temperatures. Furthermore, the heater mitigates the flooding of activation sites on the CAS.

Alternatively, a humidity or water sensor may be employed, the amount of water being proportional/indicative of the ratio of hydrogen to water present. Mass could also be measured and a mass balance conducted to calculate the ratios of the gases present. Computing means may be employed to allow for this to be done at a regular time interval. Another sensor which may be used is a thermal conductivity sensor.

Whilst it is envisaged that the combiner will be used at substantially atmospheric pressure, in some embodiments the housing may be adapted to handle elevated pressures beyond 1 bar, 10 bar, or even 100 bar. In fact the combiner is not intended to be limited by the pressure. The combiner, and the CAS within shall be of adequate size to process the stream.

It is envisaged that the present invention can be utilised in a plurality of scenarios where oxygen and hydrogen may both be components in a gaseous stream. Such as, but not limited to, the exhaust from hydrogen combustion engines. Other scenarios where the present invention may be used include scenarios where hydrogen is not fully oxidised, and should be removed for safety considerations. In a preferred embodiment, the means is utilised in combination with an electrolyser, more preferably, an AEM electrolyser. Some electrolysers utilise a water tank, or liquid degassing tank. Such apparatus often have a gaseous outlet. In a preferred embodiment of the present invention, the CAS will be placed in communication with such a gaseous outlet. A gaseous outlet on a water tank may utilise a demister, amongst other well-established applications.

In some embodiments a drain or other means for removing water may be provided near or after the CAS to prevent flooding. It is envisaged that a valve or other means may be employed to ensure the removal of liquids only, the water may be routed to a tank for reuse in the system.

According to a second embodiment of the present inventions, there is provided an electrochemical cell comprising:
a membrane electrode assembly (MEA) wherein the MEA comprises:
   an anode layer, a cathode layer and an ion exchange membrane situated therebetween;
   an anodic compartment adapted to operate at a first pressure,
   a cathodic compartment adapted to operate at a second pressure, and
   an electrically insulated catalytically active structure (CAS), wherein the CAS is:
      situated in the compartment with a relatively lower pressure, and
extending across a substantial majority of the cross-section said compartment, such that, in use, the principal gas stream flows therethrough.

As used herein electrochemical cell is intended to include, but is not necessarily limited to electrolyser, fuel cells, or electrochemical compressors. Such devices may be traditional alkaline, or PEM, but are preferably an-ion exchange membranes. A single electrolytic cell may be used as an electrolyser, or a stack of such electrolytic cells may be used as an electrolyser. The same is true for fuel cells and electrochemical compressors.

As referred to herein, an electrochemical cell has both an anodic compartment and a cathodic compartment. The anodic compartment begins at the ion-exchange membrane and extends outwards towards the anode catalyst and the compartment housing said components. Conversely, the cathodic compartment extends from the other side of said ion exchange membrane outwards encompassing the compartment housing the cathode.

Whilst it is envisaged the presently described embodiment will work with either an an-ion exchange membrane (AEM) or proton exchange membrane (PEM), in the preferred embodiment it is an AEM electrochemical device. Even more preferable is that it is an AEM electrolyser operating with a dry-cathode. Even more preferably the dry cathode embodiment sees the cathode at a higher pressure than the anode. The combiner described in the first embodiment is also preferred to be used on the anodic downstream of an AEM electrolyser operating with a dry cathode. The dry cathode may be at any pressure but is preferably in the range of 1 bar 100 bar, more preferably still 10 bar to 50 bar, yet more preferably still between 30 bar and 40 bar and most preferably at approximately 35 bar. Some jurisdictions require lower caps when working with hydrogen, such as in Japan where an upper limit of 8 bar is observed.

Conversely, the combiner may be in the cathode if the electrochemical cell is operating at elevated pressures in the anode.

Whilst the CAS shall be electrically insulated from the MEA, in the preferred embodiment, it is still close, and abuts, the electrode, regardless of the compartment it is housed within. Electric insulation of the CAS from other components may be achieved by an ionomer thin film being applied on one or both sides, or by placing the CAS between two ultra-thin membranes, or a combination thereof.

The adaptation for the CAS to contact the substantial majority of the gas is preferred to be the CAS extending across the substantial majority, if not all, of the cross-sectional area of the housing or compartment the CAS is housed within.

This embodiment has been found to have a benefit to the cathode kinetics, especially for electrolysers operating with a dry cathode, as well as ensuring the membrane is sufficiently hydrated. These two unexpected benefits help to improve the efficiency as well as adding another layer of safety to the electrolyser. Further, it reduces the likelihood of a mixed potential being present with all benefits associated thereto. Adopting the present arrangement is more beneficial to AEM based electrochemical devices than in PEM electrolysers.

The present invention is envisaged as being useful in a reversible fuel cell utilizing either an AEM or PEM. In such an embodiment, the anode is active for both oxygen evolution and hydrogen oxidation and will be adversely affected by a mixed potential. Hence the benefit of the presently described invention.

In the preferred embodiment the cathodic compartment is substantially dry, with no liquid being actively introduced to it. Such an electrochemical device is referred to as operating with a dry cathode. It is envisaged that the CAS may be used anywhere in the anodic compartment an electrochemical device operating with a dry cathode. Alternatively, the combiner may be placed anywhere downstream of the anodic outlet wherein hydrogen may be present in the predominantly oxygen stream. The hydrogen being present due to crossover, crossover occurring when the hydrogen is produced at elevated pressures, a benefit of operating with a dry cathode.

The second embodiment may include any and all of the applicable variations and embodiments discussed for the first embodiment, such as the catalyst, CAS, and use of temperature sensing means and processing the information to determine the ratio of gases present.

The CAS may be made in a variety of ways and shall depend upon the nature of the support used. Generally a catalyst solution is used, optionally an ionomer solution may be used to provide insulation from abutting components. The catalyst solution is sprayed upon the support, the support being any suitable structure as discussed above, with the optional ionomer solution being applied if desired. Methodologies are known from the manufacture of MEAs and include spraying, painting, slot die, decal and more.

It is envisaged that the recombination catalyst can have a concentration gradient either increasing or decreasing in concentration when moving from the anodic compartment towards the ion exchange membrane. Alternatively, it is envisaged the CAS may have the catalyst in a substantially uniform concentration throughout the CAS. The concentration of catalyst may also vary within the CAS.

For the purpose of electrically isolating the CAS from other components such as the anode layer, or the MEA generally, an ionomer layer can be used. Preferably, the ionomer layer is an ultra-thin film.

In an alternative embodiment, the CAS is combined with the anodic catalyst layer to create a mixed catalyst layer recombining crossover hydrogen with the release oxygen prior to venting via a downstream outlet, said outlet optionally comprising a demister.

According to another aspect of the present invention, there is provided a method, in a system that utilizes a principal gas stream comprising hydrogen and oxygen, for removing contaminant hydrogen from a principal gas stream comprising predominantly oxygen, or vice versa, the method comprising providing, in said system, a combiner device substantially as described above such that said principal gas stream flows through the housing from the inlet to the outlet.

The demisters utilised in the present invention has certain preferred structural characteristics. Preferably, the demister is a porous substrate having pores below 100 microns in diameter, more preferably below 50 microns, and yet more preferably still between 1 and 20 microns. Surface treated pores can be submicron.

In a preferred embodiment, the demister will be a metal foam or sintered metal substrate, the material chosen to be compatible with any potential alkaline vapours (i.e. stainless steel, Ni, or alloys thereof), specifically avoiding metals such as Zn, Sn, Al, and their alloys. The demister substrate could also be metal free such as ceramic, or sintered ceramic, such as alumina, or carbon based.

The distribution of pores may be within a small range, substantially uniform in size around a desired value, i.e. a distribution around 5 microns, or it may be bimodal selecting for 2 different pore sizes (either homogenously or via a gradient, such as a metal membrane filter skin variant - 10 micron bulk and 1 micron or submicron surface film). Having more than one pore size distribution, or having a gradient thereof, would allow for condensation of water vapor and subsequent capillary action pulling liquid water to the smaller pores.

Once fully saturated, and depending on the geometry, the porous media will slowly drain through both gravitational and phase change induced flow. The latter process (PCI - phase change induced flow) is significant if the demister configuration is substantially connected to the CAS housing - the heat of recombination will continually cause PCI to allow for condensation of influxing water on the cold side and subsequent evaporation/draining on the hot side. The main function of the demister is to prevent premature water introduction before the recombiner has reached a sufficiently high steady state temperature (i.e. between 70-90C) where any water introduced or generated is subsequently evaporated and vented out of the CAS.

The demister may be mounted on the inlet of the CAS/recombiner to prevent upstream vent-line condensed water from immediately entering the reaction chamber upon system start up and in parallel make use of the waste heat generated to ensure the demister never fully imbibes. If the CAS generates more water than is introduced in the influent during electrolyser/system start up, then a demister on the outlet could wick away liquid water initially generated in the CAS until it heats up to its proper steady state. A demister further upstream would be used if the electrolyser vent-line water condensate is determined to be the main and most detrimental source of water in the system.

Preferably the demister is upstream of the recombiner CAS, removing excess water before the CAS to prevent flooding. In an alternative embodiment the demister is downstream of the CAS this accommodates the water generated by the recombiner. Yet another embodiment utilises two demisters, one up-stream and one down-stream of the CAS.

In a preferred embodiment, it is envisaged that the CAS is provided in a (removable, replaceable) cartridge style housing, said cartridge being adapted to allow for replacement of the CAS should the catalyst become fouled, denatured or otherwise ineffective, without the need to replace the entire component thereby reducing maintenance cost and downtime.

It is also envisaged that waste heat from the recombiner may be utilised to preheat other areas of the system, or as part of a refrigeration cycle to act as cooling means for other parts of the system.

To help understanding of the invention, a specific embodiment thereof will now be described by way of example and with reference to the accompanying drawings, in which:

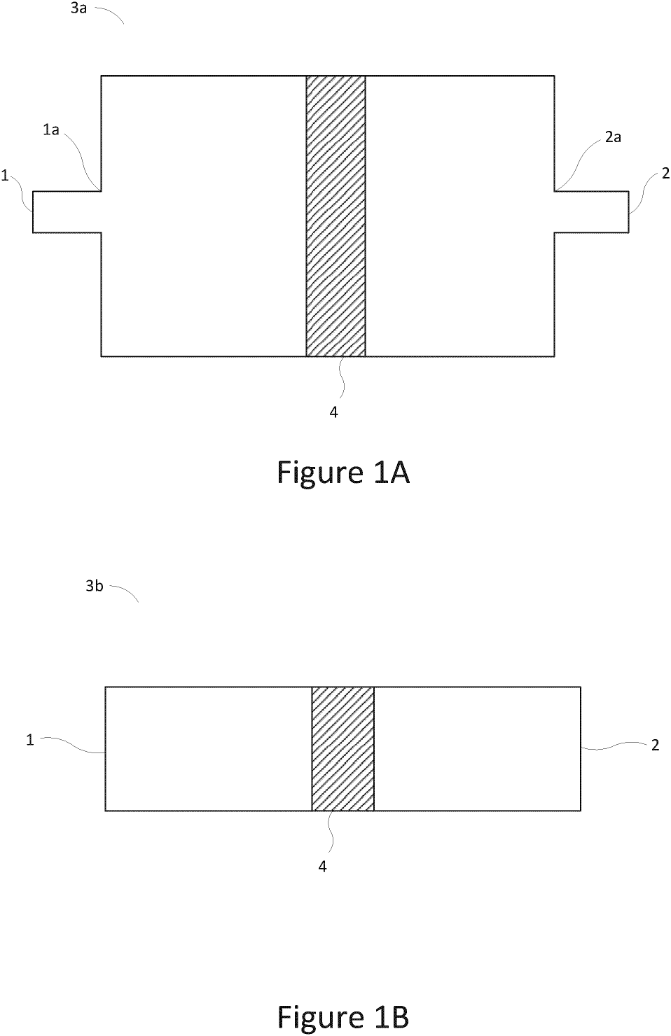

FIG. 1A and FIG. 1B each illustrate schematically a combiner in accordance with a first embodiment of the present invention;

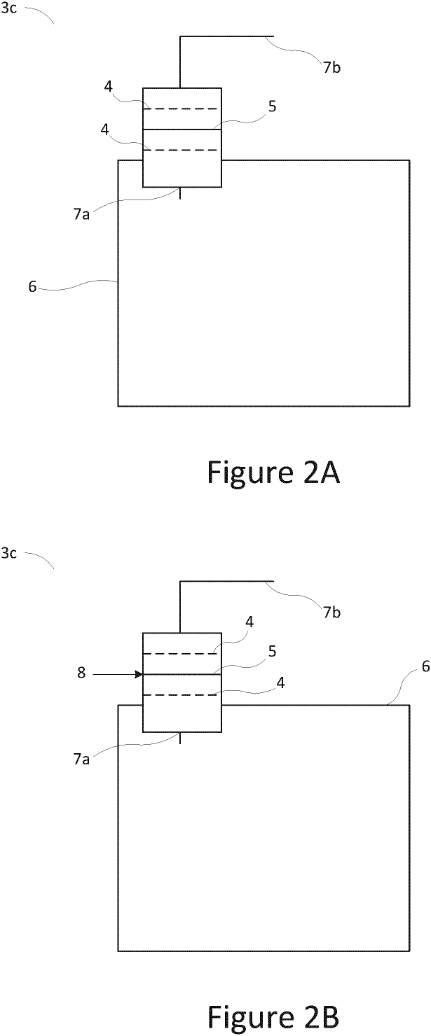

FIG. 2 illustrates schematically a combiner in accordance with an embodiment of the present invention, coupled with a demister;

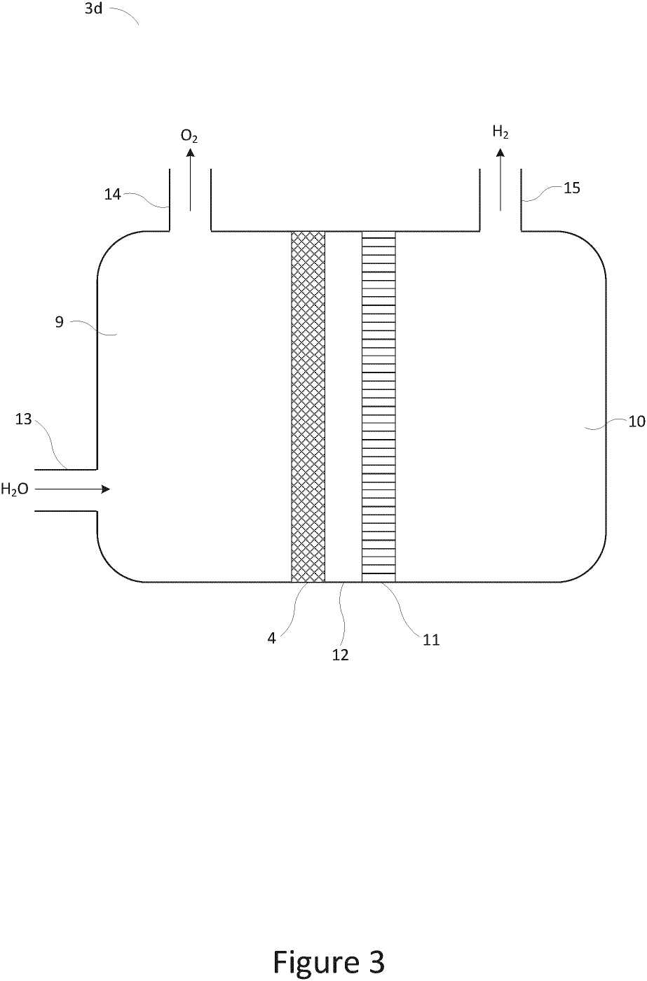

FIG. 3 illustrates schematically a combiner in accordance with a second embodiment of the present invention;

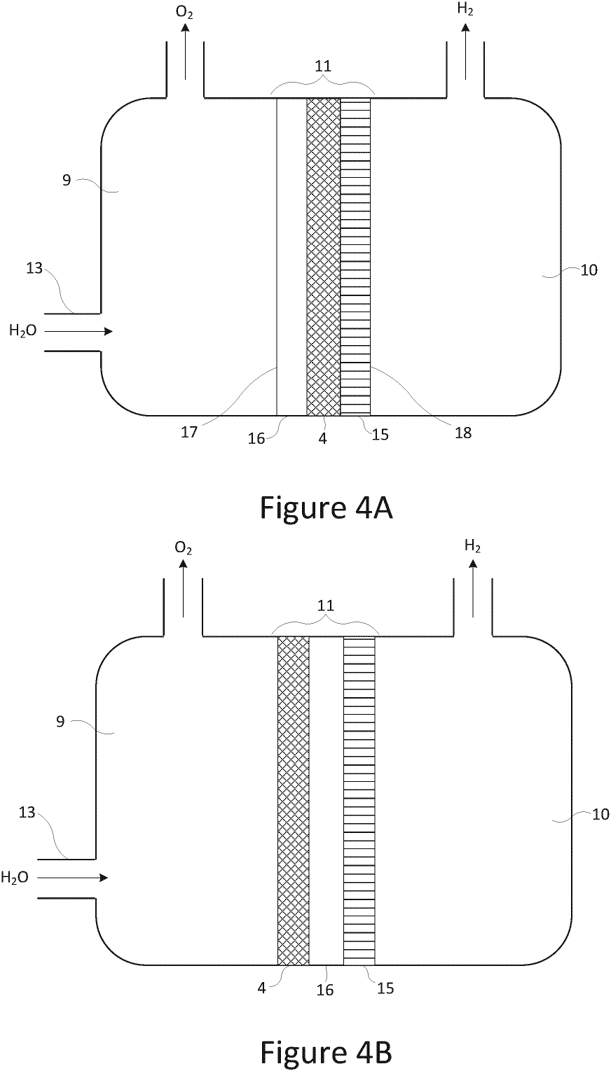

FIG. 4A and FIG. 4B each illustrate schematically a respective alternative embodiment of the present invention;

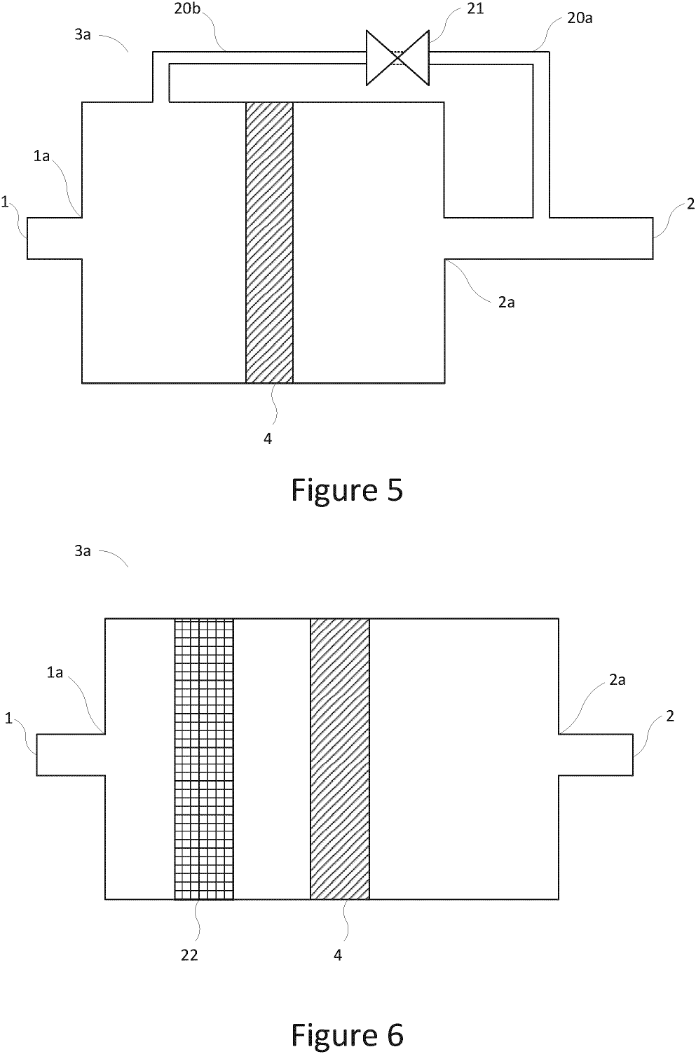

FIG. 5 illustrates schematically a combiner in accordance with an embodiment of the present invention, utilising a recycle loop; and

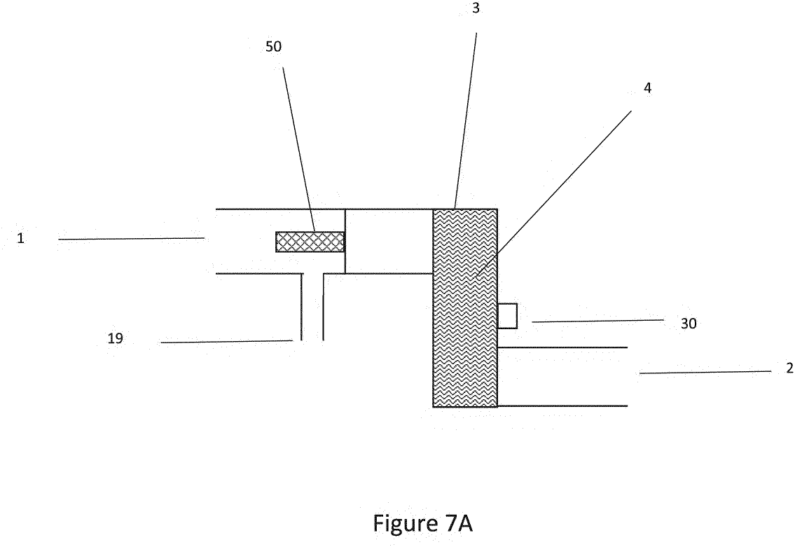

FIG. 6 illustrates schematically a combiner in accordance with an embodiment of the present invention.

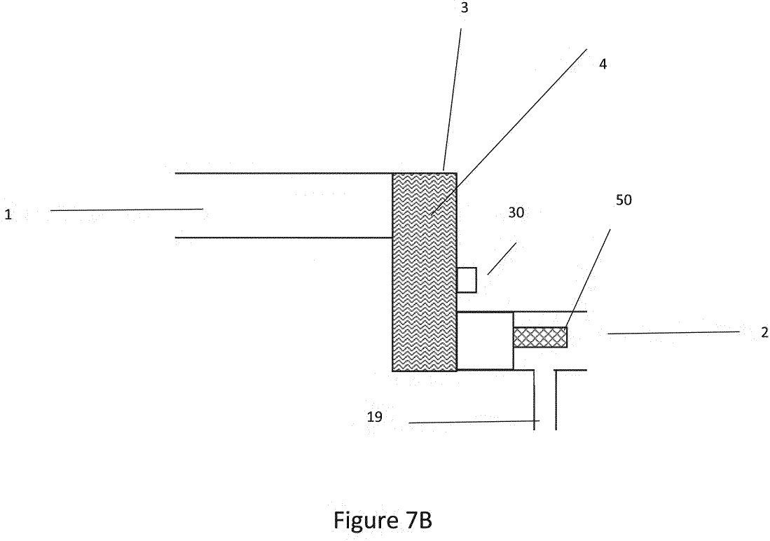

FIG. 7A and FIG. 7B Illustrates schematically a combiner in accordance with the present invention

Referring to FIG. 1A there can be seen the housing 3a, a pipe 1 introducing the gas to be purified via inlet 1a. Within the housing 3a there is present the CAS 4. At the CAS 4, the recombination reaction occurs, thereby removing the hydrogen in the predominantly oxygen stream, or oxygen in the predominantly hydrogen stream. The purified gas can leave via outlet 2a to pipe 2. Means for causing the flow of gas are not shown herein and should be known to the individual of ordinary skill in the art.

In the embodiment depicted by FIG. 1A, a stream of gas comprising predominantly oxygen with some contaminant hydrogen enters the inlet 1a where it contacts the CAS 4. At the CAS, recombination occurs combining hydrogen with oxygen to form water. Means for the removal of said water are not shown. Also not shown are an optional sensor, temperature and/or humidity, for the detection of concentration of the contaminant hydrogen. One or more temperature sensors would typically be coupled to the CAS, whereas one or more humidity sensors would typically be located shortly after (i.e. down stream of) the CAS.

The embodiment illustrated in FIG. 1B of the drawings is similar in many respects to that of FIG. 1A, but differs in the geometry of housing 3b. More generally, the geometry of the housing may be dictated by various characteristics and parameters of the system, including, for example, the pressure at the inlet and/or a desired pressure at the outlet.

As referenced above, the embodiment depicted in FIG. 1B is similar in most other respects to that of FIG. 1A, and operation thereof would occur in a similar manner to that described above in respect of FIG. 1A.

FIG. 2A illustrates an embodiment of the present invention in combination with a water tank 6. Such a water tank is commonly used with an electrolyser. In a typical such electrolyser arrangement, and as will be well understood by a person skilled in the art, the electrolyte flows from the electrolytic stack to the water tank 6 where it is recirculated. With AEM electrolysers, and other types, the dissolved gas leaving the liquid in the water tank 6 may contain a combination of oxygen and hydrogen. A demister housing 3c houses both the CAS 4, and a demister pad 5. The gas enters the housing 3c, from the water tank 6, via inlet 7a. The CAS 4 is shown by dashed lines denoting it can be above or below (i.e. upstream or downstream of) the demister pad 5, depending on whether the catalyst used is hydrophobic or hydrophilic respectively. A hydrophilic catalyst may require further drying means after recombination (not shown) if a dry outlet is needed. After combination, the gas leaves the housing 3c via outlet 7b.

A demister may be used to conserve the liquid levels within the electrolyser to reduce the frequency of maintenance such as refilling. The connections to and from the water tank not related to the outward flow of gas have not been shown here, and should be known to an individual of ordinary skill in the art.

The embodiment illustrated in FIG. 2B differs from that of FIG. 2Ain that ambient air is introduced to the CAS via a second inlet 8. A fan may be used for the introduction of ambient air, or other gas. If operating at pressure, a compressor may be used instead of a fan to allow the introduction of air to the CAS 4.

In the arrangements of both FIGS. 2A and 2B, liquid containing dissolved gases, predominantly oxygen with some hydrogen, enters the water tank 6, preferably configured as a liquid degassing tank. The dissolved gases are removed from the liquid, and travel to the demister 3c. Within this housing 3C, the demister pad 5 can retain liquid levels, and the CAS 4 ensures that only a safe gas mixture is vented from the outlet 7b.

FIGS. 2A and 2B may also combine the demister and CAS such that they are a single component. Additionally, the device may be adapted to include a recombiner as seen in FIG. 7 before and/or after a demister, with the demister in this embodiment not having a CAS. The water in FIG. 2 not shown.

In FIGS. 2A and 2B the water in the tank 6 degases, the gas and water vapour enter the housing 3c via inlet 7a before crossing the demister pad 4 then CAS 5, or the CAS 5 then demister pad 4, the order depending upon the embodiment. The demister and CAS may also be combined. The water vapour coalesced by the demister flows back down to the water tank back through the inlet 7a. For embodiments with the demister after the CAS a bypass (not shown) may be provided to allow for flow of coalesced water vapour (bypassing the CAS) back into the tank 6, or to drainage, to prevent flooding. The housing 3c may also be rotated to prevent flooding of the CAS.

Referring to FIG. 3 of the drawings, an embodiment of the invention in the form of an electrolytic cell is illustrated schematically, having a housing 3d. In this embodiment, water or an electrolyte enters the anode 9 of the cell, via inlet 13. The MEA 11 is illustrated as being electrically isolated (at 12) from the CAS 4. In operation, hydrogen is generated in the cathode 10 of the cell and leaves via outlet 15. When operating at pressure, hydrogen can crossover from the cathode 10 to the anode 9, hence the need for hydrogen removal. The CAS 4 acts to combine the crossed-over hydrogen with the oxygen generated via electrolysis of water. The relatively pure oxygen stream then leaves the anode 9 via the outlet 14. The electrolytic cell depicted in FIG. 3 is configured to operate with a dry cathode.

FIG. 4A shows, like FIG. 3, an electrolytic cell configured to operate with a dry cathode. The difference can be found in the MEA 11. In this embodiment, the an-ion exchange membrane 15 is in close contact with the CAS 4, and an ionomer layer (or thin cast membrane)16, normally an ultra-thin film, wherein the film is normally polymeric, separates the CAS 4 from the anode layer 17. The cathode layer 18 can be seen on the other side of the an-ion exchange membrane. In the embodiment illustrated in FIG. 4B of the drawings, the ionomer layer 16 separates the CAS from the ion-exchange membrane.

The electrolytic cells illustrated in FIGS. 3, 4A and 4B of the drawings work as follows. Electrolyte enters the anodic compartment via inlet 13. Electrolysis occurs with hydrogen being generated in the cathodic compartment 10 to a pressure higher than in the anodic compartment 9. As a result, some hydrogen may crossover to the anodic compartment 9 (wherein oxygen is being generated). This mixture of oxygen and hydrogen is present in the anodic compartment only, and/or downstream from the anodic compartment. The CAS 4 being in said anodic compartment causes recombination of oxygen and hydrogen to form water, thereby removing the minority contaminant gas.

FIG. 5 depicts an embodiment of the present invention similar in many respects to that depicted in FIG. 1a. in that the housing 3a has a pipe 1 entering via inlet 1a; and, after (i.e. downstream of) the CAS 4, there is the outlet 2a to pipe 2. In this case. branching from pipe 2, there is a recycle loop comprising a feed 20a to a valve 21, wherein the recycle loop enters the housing via pipe 20b. Alternatively the recycle loop could be further upstream of the CAS 4. Other embodiments may be envisaged by a person skilled in the art, and modifications and variations can be made to the described embodiments without departing from the spirit of the present invention as defined by the appended claims. Control means for the valve 21 are not shown. Also not shown is the BOP in pipe 2 for ensuring a full recycle occurs.

FIG. 6 depicts an alternative embodiment of the present invention similar to those described with reference to FIGS. 1A and 1B, wherein a hydrogen reservoir 22 is employed. In general, the hydrogen reservoir is typically a metal hydride, with options and alternatives disclosed above. The hydrogen reservoir is located, in this embodiment, prior to (i.e. upstream of) the CAS 4. Means for triggering the release of reserved hydrogen in the reservoir 22 are not shown in FIG. 6, but are disclosed above.

An embodiment combining those of FIGS. 5 and 6 could result in the reservoir 22 being downstream of the housing but before the recycle begins at 20a. This would ensure any contaminant gas not recombined is not vented or passed further downstream where issues may arise.

Any of the embodiments may be adapted to operate as a detector and not just a combiner, by the introduction of temperature sensing means, and computing means to calibrate the temperature detected to that expected at different ratios of contaminant gases. Such means are not depicted herein. Alternatively, or in addition, humidity sensors and similar computing means may be employed. The important thing here is that a sensor of a variety of types may be configured to allow for the calculation of the ratio of gases present, and any variant utilising such an approach in combination with a combiner as claimed herein should be considered within the scope of the invention.

According to FIG. 7A there is shown a combiner in accordance with the present invention. A gaseous stream from a device such as an electrolyser comprising predominantly hydrogen with some oxygen and water/water vapour enter the inlet 1. Structure 50 is a standalone, or in an alternative embodiment combined flame arrestor/demister/sintered metal filter. The water/water vapour coalescing and draining via water outlet 19, valves etc. not shown with the water going to drainage or water tank or other destination. The gas enters the housing 3 comprising the CAS 4. Within the housing the exothermic recombination occurs. Attached to the housing is a heater 30 with means for measuring temperature. Also not shown is the connection to an option PID or other controller adapted to run the heater to ensure the CAS maintains a desired temperature, heating during start up and shut down where crossover/contaminant levels are low ensures good operation of the recombiner. Additional computing means are not shown which are adapted to alert the user if the temperature is too high indicating excessive contaminant gases. After the CAS 4 the treated gas leaves the recombiner via outlet 2. Also not shown is the optional insulation and/or polymeric coating of the component.

FIG. 7B largely reflects FIG. 7A with the only difference being the demister/flame arrestor is downstream of the CAS 4. Not shown is an embodiment with demister/flame arrestor both up and down stream of the CAS 4. The water outlet 19 in FIG. 7B is optional as the coalesced water may be allowed to exit the vent line 2.

For reasons of practicality, it is not preferred but is possible that the electrolytic stack or cells thereof may be provided with a recombiner before and/or after a demister as seen in FIG. 7 or another in accordance with the present invention. In the pref3erred embodiment the demister and recombiner are situated on the water tank to which electrolyte and generated gases with contaminant are transferred.

The embodiments depicted may be amended or combined to include any of the features described in the document, such as the demister pad being the CAS, or the addition of a hydrogen or oxygen reservoir, or recycle loop for the downstream gases.

The invention is not intended to be restricted to the details of the above described embodiment. For instance, the language used refers to the removal of hydrogen in a stream containing oxygen. Conversely the device could be used and recalibrated for the removal of oxygen in a predominantly hydrogen-based stream.

The invention is not intended to be limited to the field of electrolysers. In fact, it could be utilised to detect and remove either hydrogen or oxygen from a stream comprising both gases in any application. It is envisaged that the present invention could be adapted for use in a variety of applications where two gases are in a stream and can be recombined. When such reactions are exothermic, the concentrations/ratio may be adapted in the same way. Other means may be provided to remove other contaminants, such as CO₂ scrubbers, for example.

It is noted that other contaminants may be present, and other means of removal, scrubbing or detecting may also be provided in such instances.

The invention is not necessarily intended to be limited to the support upon which the catalyst is held.

For the embodiment wherein the CAS is within the electrochemical cell, the cell itself should be construed as the housing.

The present invention is not intended to be limited by the location of either the anode or cathode catalyst in embodiments claimed within an electrochemical cell.

In any embodiment the recombiner with CAS is intended to be placed between a device such as, but not necessarily limited to, an electrolyser and a vent line.

1. A combiner device for, in use, removing a hydrogen contaminant in a principal gas stream comprising predominantly oxygen, or vice versa, with said combiner device comprising:
a catalytically active structure (CAS) comprising a housing having an inlet and an outlet;
a first pipe coupled to the inlet for conveying said principal gas stream into the housing such that it flows from the inlet to the outlet, and an exhaust pipe for conveying said principal gas stream away from said housing;
the CAS further comprising a structural element comprising or including a catalytic material operable to combine hydrogen and oxygen to form water, the structural element being located within the housing, part way between the inlet and the outlet, and extending across a substantial majority of a cross-section thereof, such that, in use, the principal gas stream flows therethrough.

2. The combiner device of claim 1, wherein the CAS is configured to combine hydrogen and oxygen to form water when the quantity of the contaminant gas in the principal gas stream is above a predetermined amount, the device further comprising supplementing means for increasing an amount of the contaminant gas in the principal gas stream to above said predetermined threshold so as to ensure that combination by the CAS of hydrogen and oxygen in said principal gas stream occurs.

3. The combiner device of claim 2, wherein said supplementing means comprises either:
means for recirculating the principal gas stream from downstream of the CAS back to upstream thereof, or
a reservoir containing the contaminant gas, the reservoir being adapted to release said contaminant gas under a predetermined condition.

4. The combiner device of claim 3, wherein the reservoir is a metal hydride.

5. The combiner device of claim 1, configured to simultaneously recombine the contaminant gas with the principal gas to form water, and detect the presence of said contaminant gas.

6. The combiner device of claim 5, further comprising one or more of the following sensors is used for the detection of the contaminant gas:
a humidity sensor,
a temperature sensor,
a thermal conductivity sensor.

7. The combiner device of claim 6, wherein the one or more sensors is coupled to computing means for determining the amount of a contaminant gas present in the principal gas stream.

8. The combiner device of claim 1 coupled with a demister, the CAS being either:
upstream of a demister pad,
downstream of a demister pad, or
combined with a demister pad.

9. The combiner device of claim 8, wherein the demister additionally acts as a flame arrestor, preferably wherein the demister is attached to the inlet.

10. The combiner device of claim 8, wherein the demister is a microporous material, preferably one of: a foam or sintered material, preferably a foam or sintered metal; a ceramic, preferably a sintered ceramic; or a carbon based material.

11. The combiner device of claim 1, further comprising means for the removal and optional recycling of the generated liquid.

12. The combiner device of claim 1, wherein the structural element comprises a backbone of: carbon black, metal oxides including ceramics, a polymeric film, metal foam, zeolitic structures, or metal organic frameworks.

13. The combiner device of claim 1, further comprising means for the introduction of ambient air to the principal gas stream.

14. The combiner device of claim 1, wherein the catalytic material is platinum, palladium or an alloy thereof.

15. The combiner device of claim 1, wherein the catalytic material is a non-PGM material including metal alloys, ceramics, chalcogenides, pnictogenides, organometallics, or other metal complexes.

16. An electrochemical cell comprising:
a membrane electrode assembly (MEA) wherein the MEA comprises:
an anode layer, a cathode layer and an ion exchange membrane situated therebetween;
an anodic compartment adapted to operate at a first pressure,
a cathodic compartment adapted to operate at a second pressure, and
an electrically insulated catalytically active structure (CAS), wherein the CAS is:
situated in the compartment with a relatively lower pressure, and
extending across a substantial majority of the cross-section said compartment, such that, in use, the principal gas stream flows therethrough.

17. The electrochemical cell of claim 16, comprising any one of: an electrolyser, AEM or PEM, a fuel cell, reversible fuel cell, electrochemical compressor, or an AEM electrolyser with a dry cathode preferably wherein the AEM electrolyser with the dry cathode is configured to operate with the dry cathode at an elevated pressure.

18-19. (canceled)

20. The electrochemical cell of claim 16, wherein the CAS is insulated from other components of the electrochemical cell by an ionomer thin film or ultra-thin membrane on one or both sides, or a combination thereof.

21. A method, in a system that utilizes a principal gas stream comprising hydrogen and oxygen, for removing contaminant hydrogen from a principal gas stream comprising predominantly oxygen, or vice versa, the method comprising providing, in said system, a combiner device according to claim 1 such that said principal gas stream flows through the housing from the inlet to the outlet.

22. A method according to claim 21, wherein:
said system comprises an electrochemical cell; and/or
said principal gas stream comprises between 0.4 and 20% contaminant gas; and/or
the operating temperature is between 20 and 100° C.

23-24. (canceled)
